(19) United States
(12) Patent Application Publication
(10) Pub. No.: US 2025/0304135 A1
(43) Pub. Date: Oct. 2, 2025

(54) Autonomous Robot with Force Sensing User Handlebar

(71) Applicant: Robust AI, Inc., San Carlos, CA (US)

(72) Inventors: Jamie Luong, San Mateo, CA (US); Benjie Holson, Sunnyvale, CA (US); Justine Rembisz, San Carlos, CA (US); Heather Klaubert, San Jose, CA (US)

(73) Assignee: Robust AI, Inc., San Carlos, CA (US)

(21) Appl. No.: 18/655,609

(22) Filed: May 6, 2024

Related U.S. Application Data
(60) Provisional application No. 63/571,352, filed on Mar. 28, 2024.

(51) Int. Cl. B62B 5/00; B62B 3/00

(52) U.S. Cl. CPC B62B 5/0069; B62B 5/004; B62B 3/002

(57) ABSTRACT

An autonomous robot drive assembly includes a force sensing assembly. The force sensing assembly is a force sensing handlebar that is mounted in a specific orientation to allow for a user to manipulate the robot. The handlebar is configured to allow a user to manipulate the handlebar by providing force to the handlebar to move the handlebar from a neutral position. The manipulation of the handlebar causes instructions to be determined for operation of the robot. Based on the manipulation of the handlebar, a drive assembly of the robot moves the robot in accordance with the instructions.

### CROSS-REFERENCE TO RELATED APPLICATIONS

This application claims the benefit under 35 U.S.C. § 119(e) of U.S. Provisional Patent Application 63/571,352 (Attorney Docket No. RBAIP011P) by Luong et al., entitled: “Autonomous Robot with Force Sensing User Handlebar”, filed on 2024 Mar. 28, which is incorporated herein by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent application relates generally to user control systems for autonomous robots, and more specifically to a force sensing handlebar to allow a user to manipulate an autonomous robot while positioned proximate the autonomous robot.

### DESCRIPTION OF RELATED ART

Autonomous and semi-autonomous robots can be operated without user input, but there may be situations where user operation is desirable. Typically, user operation of autonomous and semi-autonomous robots are through a control interface, such as a user drive that includes a graphical user interface to allow a user to control the autonomous or semi-autonomous robot from the point of view of the robot. However, autonomous and semi-autonomous robots may operate in environments with other human workers. Such workers may not be specifically tasked with operating the autonomous and semi-autonomous robots and may not include specific devices to do so, but may still find themselves in situations where they may need to operate such autonomous and semi-autonomous robots.

### Overview

Described herein are systems and techniques for a force sensing handle assembly. In a certain embodiment, an autonomous robot may be disclosed. The autonomous robot may include a drive assembly, a controller, and a handle assembly. The handle assembly may include a handlebar, a first fixture coupled to the handlebar at a first end of the handlebar, a second fixture coupled to the handlebar at a second end of the handlebar, a first sensor comprising a first sensor first portion coupled to the handlebar proximate the first end of the handlebar and a first sensor second portion disposed proximate the first sensor first portion, where the first sensor first portion is configured to move relative to the first sensor second portion in response to movement of the handlebar, and where the first sensor second portion is configured to detect the relative movement of the first sensor first portion and output first sensor data to the controller, and a second sensor comprising a second sensor first portion coupled to the handlebar proximate the second end of the handlebar and a second sensor second portion disposed proximate the second sensor first portion, where the second sensor first portion is configured to move relative to the second sensor second portion in response to movement of the handlebar, and where the second sensor second portion is configured to detect the relative movement of the second sensor first portion and output second sensor data to the controller.

In some implementations, the handlebar is a vertically oriented handlebar. The first sensor first portion may be configured to be disposed in a first neutral position, and where the second sensor first portion is configured to be disposed in a second neutral position. The first neutral position and the second neutral position may be located along different vertical axes.

In some implementations, the first sensor data is associated with the relative movement of the first sensor first portion to the first sensor second portion.

In some implementations, the second sensor data is associated with the relative movement of the second sensor first portion to the second sensor second portion.

In some implementations, the controller is configured to receive the first sensor data and the second sensor data, determine, based on the first sensor data and the second sensor data, user interaction with the handlebar, and cause the drive assembly to provide motive force. The user interaction may be determined to be a translation of the handlebar, and the motive force may result in translational movement of the drive assembly. The user interaction may be determined to be a twist of the handlebar, and the motive force may result in rotational movement of the drive assembly.

In some implementations, handle assembly further includes a first compliant material, coupled to the first fixture and the handlebar and configured to allow the handlebar to move relative to first fixture, and a second compliant material, coupled to the second fixture and the handlebar and configured to allow the handlebar to move relative to second fixture.

In another embodiment, a handle assembly may be disclosed. The handle assembly may include a handlebar, a first fixture coupled to the handlebar at a first end of the handlebar, a second fixture coupled to the handlebar at a second end of the handlebar, a first sensor comprising a first sensor first portion coupled to the handlebar proximate the first end of the handlebar and a first sensor second portion disposed proximate the first sensor first portion, where the first sensor first portion is configured to move relative to the first sensor second portion in response to movement of the handlebar, and where the first sensor second portion is configured to detect the relative movement of the first sensor first portion and output first sensor data, and a second sensor comprising a second sensor first portion coupled to the handlebar proximate the second end of the handlebar and a second sensor second portion disposed proximate the second sensor first portion, where the second sensor first portion is configured to move relative to the second sensor second portion in response to movement of the handlebar, and where the second sensor second portion is configured to detect the relative movement of the second sensor first portion and output second sensor data.

In some implementations, the handlebar is configured to be vertically oriented. The first sensor first portion may be configured to be disposed in a first neutral position, and where the second sensor first portion is configured to be disposed in a second neutral position. The first neutral position and the second neutral position may be located along different vertical axes.

In some implementations, the first sensor data is associated with the relative movement of the first sensor first portion to the first sensor second portion.

In some implementations, the second sensor data is associated with the relative movement of the second sensor first portion to the second sensor second portion.

In some implementations, the handle assembly may further include a controller, configured to receive the first sensor data and the second sensor data, determine, based on the first sensor data and the second sensor data, user interaction with the handlebar, and provide drive data to a robotic drive assembly. The controller may be configured to determine that the user interaction is a translation of the handlebar, and the drive data may be configured to cause the robotic drive assembly to provide translational movement. The controller may be configured to determine that the user interaction is a twist of the handlebar, and the drive data may be configured to cause the robotic drive assembly to provide rotational movement.

In some implementations, the handle assembly further includes a first compliant material, coupled to the first fixture and the handlebar and configured to allow the handlebar to move relative to first fixture, and a second compliant material, coupled to the second fixture and the handlebar and configured to allow the handlebar to move relative to second fixture.

### BRIEF DESCRIPTION OF THE DRAWINGS

The included drawings are for illustrative purposes and serve only to provide examples of possible structures and operations for the disclosed inventive systems, apparatus, methods, and computer program products for a force sensing handlebar to allow a user to operate an autonomous or semi-autonomous robot capable of autonomous movement. These drawings in no way limit any changes in form and detail that may be made by one skilled in the art without departing from the spirit and scope of the disclosed implementations.

FIG. 1 illustrates a perspective view of an autonomous robot, configured in accordance with one or more embodiments.

FIG. 2 illustrates a perspective view of a force sensing handlebar, configured in accordance with one or more embodiments.

FIG. 3 illustrates a perspective view of portions of a force sensing handlebar, configured in accordance with one or more embodiments.

FIG. 4 illustrates a top view of a force sensing handlebar for an autonomous robot in a first manipulated position, configured in accordance with one or more embodiments.

FIG. 5 illustrates a top view of a force sensing handlebar for an autonomous robot in a second manipulated position, configured in accordance with one or more embodiments.

FIG. 6 is a block diagram of a drive unit for an autonomous robot, configured in accordance with one or more embodiments.

FIG. 7 is a flowchart detailing a technique for utilizing a force sensing handlebar, configured in accordance with one or more embodiments.

FIG. 8 is a flowchart detailing another technique for utilizing a force sensing handlebar, configured in accordance with one or more embodiments.

FIG. 9 illustrates a perspective view of an autonomous robot with a horizontal handlebar, configured in accordance with one or more embodiments.

FIG. 10 illustrates a perspective view of an autonomous robot with a force sensing base, configured in accordance with one or more embodiments.

FIG. 11 illustrates a perspective view of portions of a force sensing base, configured in accordance with one or more embodiments.

FIG. 12 is a block diagram of a computing device, configured in accordance with one or more embodiments.

### DETAILED DESCRIPTION

### Introduction

Techniques and mechanisms described herein provide for a robot configured to operate in cooperation with people. The robot may include a drive assembly to provide motive power. The drive assembly may include a plurality of drive units, each drive unit orientable in an independent manner to that of the other drive units. Each drive unit may include a plurality of driven wheels that may be independently driven. Independent drive of each of the drive wheels of the drive assembly allows for the drive assembly to move the robot in a holonomic (without constraints in their direction of motion) manner.

The robot may include a force sensing assembly to allow for a user to manipulate the robot. The force sensing assembly may include, for example, a handlebar. The handlebar may be mounted in any orientation, such as in a horizontally or vertically mounted orientation. Additionally or alternatively, the force sensing assembly may be a force sensing base or another mechanism configured to receive physical input from a user (e.g., a hand, arm, foot, or leg of a user).

A user may manipulate the force sensing assembly by, for example, providing force to a handlebar to move the handlebar from a neutral position. The manipulation of the force sensing assembly may provide instructions to the robot and cause the drive assembly to move the robot in accordance with the instructions provided via the force sensing assembly. Such commands may, for example, override autonomous or semi-autonomous operation of the robot.

A robot may be configured as a cart capable of transporting one or more objects. The robot may operate in one of various modes. For example, in an autonomous mode the robot may operate without physical human intervention, for instance autonomously moving from one location to another and/or performing various types of tasks. As another example, in a robot-guided mode, the robot may direct a human to perform a task, such as guiding a human from one location to another. As another example, in a person-guided mode, the robot may operate in a manner responsive to human guidance. The robot may be configured to seamlessly switch between such modes, for instance with the aid of computer vision, user interaction, and/or artificial intelligence.

In some embodiments, a robot may be configured for operation in a warehouse environment. For example, the robot may be equipped and configured to perform and support warehouse operations such as item picking, item transport, and item replenishment workflows. As another example, the robot may be equipped to perform automated item pickup and/or dropoff, for instance via one or more arms or conveyer belts. As still another example, the robot may be equipped to perform automated charging and/or battery swapping. As yet another example, the robot may be equipped to autonomously navigate to a particular location, follow a user, respond to user instructions, amplify a force exerted on the robot by a user, and/or perform other types of operations. The robot may be adapted to site-specific environmental conditions and/or processes.

In some embodiments, an autonomous mobile robot configured in accordance with one or more embodiments may support omnidirectional movement. That is, the autonomous mobile robot may be capable of movement in any direction.

In some embodiments, an autonomous mobile robot configured in accordance with one or more embodiments may support holonomic movement. That is, the autonomous mobile robot may be capable of powered movement in any direction corresponding with a degree of freedom associated with the robot. For instance, a conventional automobile is not holonomic because it has three motion degrees of freedom (i.e., x, y, and orientation) but only two controllable degrees of freedom (i.e., speed and steer angle). In contrast, a conventional train is holonomic because it has one controllable degree of freedom (i.e., speed) and one motion degree of freedom (i.e., position along the track).

In some embodiments, an autonomous mobile robot configured in accordance with one or more embodiments may support omnidirectional and holonomic movement. That is, the autonomous mobile robot may be capable of powered movement and rotation in any direction from any position.

When using conventional techniques and mechanisms, onboarding autonomous mobile robots in an industrial setting takes a significant amount of time. In contrast, various embodiments described herein facilitate rapid onboarding. In some embodiments, a robot can be on-boarded without bringing a robot on-site for an initial survey. Such rapid deployment can significantly increase adoption speed.

When using conventional techniques and mechanisms, even small changes to autonomous mobile robot configuration and workflows cannot be made in real time. In contrast, various embodiments described herein provide for easy adjustments to daily workflows without intervention by a technical support team.

When using conventional techniques and mechanisms, industrial autonomous mobile robots are typically configured with expensive hardware that is customized to particular environments. In contrast, various embodiments described herein provide for autonomous mobile robots may be configured with standardized hardware and software that is easily and inexpensively applicable and adaptable to a range of environments.

When using conventional techniques and mechanisms, industrial autonomous mobile robots avoid people and typically treat them like objects. In contrast, various embodiments described herein provide for autonomous mobile robots that employ semantic perception to differentiate people from static objects and move around them intelligently. An autonomous mobile robot may thus perform and/or facilitate human-centric operations such as zone picking, human following, wave picking, a virtual conveyer belt, and user training. Such operations can increase human engagement and reduce the autonomous mobile robot's impact on foot traffic, for instance when its work is unrelated to people nearby.

When using conventional techniques and mechanisms, industrial autonomous mobile robots are difficult to troubleshoot, requiring trained employees or remote support resources to resolve issues. In contrast, various embodiments described herein provide for issue resolution by individuals using the autonomous mobile robots rather than experts with specialized training.

When using conventional techniques and mechanisms, industrial autonomous mobile robots typically provide limited interaction mechanisms. In contrast, various embodiments described herein provide for various types of user interaction mechanisms. For example, a user may interact with the autonomous mobile robot via a touch screen display and force-sensitive handlebars. Using such techniques, individuals may perform tasks such as moving heavy loads, teaching a fleet of autonomous mobile robots about new locations, and resolving issues without interacting with technical support services.

When using conventional techniques and mechanisms, autonomous mobile robots operate using centralized and cloud computing system architectures that increase cost and latency to the robots' ability to respond to rapidly changing warehouse environments. In contrast, various embodiments described herein provide for arms that employ localized processing systems such as neural network architectures. Such approaches provide for lower latency and improved performance, increasing the safety of the autonomous mobile robot and rendering it more responsive to both people and potential hazards in a physical environment.

When using conventional techniques and mechanisms, many industrial autonomous mobile robots rely on expensive LIDAR sensors that observe only a narrow slice of the surrounding environment in limited detail. In contrast, various embodiments described herein provide for autonomous mobile robots with detailed, three-dimensional views of the surrounding environment. Such configurations provide for greater safety, smarter movement and coordination, and deeper data-enabled interactions.

When using conventional techniques and mechanisms, autonomous mobile robots and automated guided vehicles treat people and dynamic objects (e.g., forklifts) as static obstacles to be avoided. In contrast, various embodiments described herein provide for autonomous mobile robots that differentiated between persistent, temporary, and in-motion objects, interacting with them fluidly and efficiently.

When using conventional techniques and mechanisms, an autonomous mobile robot cannot visually distinguish between different individuals. In contrast, various embodiments described herein provide for autonomous mobile robots that can respond to requests from particular individuals and navigate around an environment in more fluid, less disruptive ways. For instance, an autonomous mobile robot may be configured to follow a particular person around a warehouse environment upon request.

In various embodiments, elements with ordinal indicators that end with similar numbers (e.g., X06 and Y06) may be different embodiments of similar components (e.g., different embodiments of payload support features). As such, for example, the description provided for X06 may apply for Y06, and vice versa, throughout this disclosure. Furthermore, ordinal indicators of the same number, but different ending letters, (e.g., 416A and 416B) may be a plurality of equivalent or similar items or elements.

### Overall Architecture

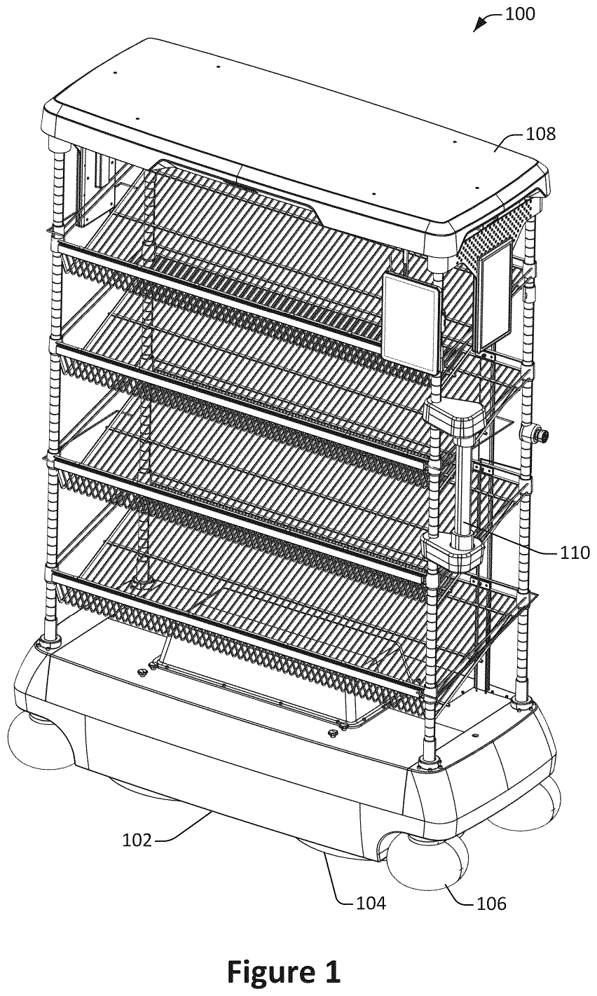

FIG. 1 illustrates a perspective view of an autonomous robot, configured in accordance with one or more embodiments. FIG. 1 illustrates autonomous robot 100, which includes drive assembly 102, payload 108, and force sensing assembly 110.

In certain embodiments, drive assembly 102 may include a plurality of drive units 104 and one or more payload support element 106. Drive unit 104 may be a drive unit that includes a plurality of powered wheels. In the embodiments described herein, the plurality of drive unit 104 may be configured to be operated, jointly or independently, to power autonomous robot 100 and provide movement to autonomous robot 100 in a backdriveable and holonomic manner.

Payload support element 106 may be one or more support features (e.g., castor wheels, sliding pads, and/or other structures that may provide stability while accommodating movement). Payload support element 106 may be disposed within portions of drive assembly 102 and/or coupled to portions of payload 108 to provide stability for autonomous robot 100. In various embodiments, payload support element 106 may be disposed or coupled to any portion of drive assembly 102 and/or payload 108 to provide stability. As described herein, “coupled” may refer to direct or indirect (e.g., with intermediate elements) relationships between elements while “connected” may refer to direct (e.g., with no intermediate elements) relationships between elements.

In certain embodiments, payload support element 106 may provide sufficient support for payload 108 to allow for the various drive units 104 to be positioned in an optimal manner to provide for predictable backdriveable and holonomic movement. Thus, payload support element 106 may provide for stability while payload 108 (which may be, for example, a shelf) is loaded or unloaded while the various drive units 104 are positioned to allow for good handling of autonomous robot 100.

Drive assembly 102 may be a drive assembly configured to couple to payload 108 to move payload 108. In various embodiments, drive assembly 102 may couple to payload 108 via any technique, such as via openings on a body (e.g., one or more portions of payload 108 may be inserted into one or more openings disposed within the body of drive assembly 102), mechanical fasteners (e.g., bolts, screws, and/or other techniques), permanent or semi-permanent techniques such as welding, adhesives, and/or other such techniques. As such, drive assembly 102 may be a module that may, in certain embodiments, be coupled to any number of different versions of payload 108. Payload 108 may be a commercially available (e.g., off-the-shelf) utility body, such as a shelf, or may be an item customized for use with drive assembly 102.

Payload 108 may be any commercially available or custom item. In various embodiments, payload 108 may be any tool that may assist in operations. For example, payload 108 may be a cart (which may include a mounted shelf), a mounted robot, a container box, and/or other such item. While description may be provided in the manner of autonomous carts and shelves, it is appreciated that other embodiments of payload 108 are within the scope of the disclosure, such as assembly robots.

Force sensing assembly 110 may be, for example, a vertically oriented handle (e.g., a handle with a major axis that is within 10 degrees of vertical) coupled to autonomous robot 100 and communicatively coupled to drive assembly 102. Other embodiments of force sensing assembly 110 may include a handlebar oriented in another orientation (e.g., a horizontally oriented handle within 10 degrees of horizontal) a force sensing base (e.g., a base, such as the base of drive assembly 102, configured to receive input from a foot of a user) of autonomous robot 100, and/or other such mechanism or technique configured to receive directional input from a user. Such input may, for example, allow for the distinguishing of different types of inputs, such as inputs that are intended to cause autonomous robot 100 to translate in a certain direction as well as inputs that are intended to cause autonomous robot 100 to rotate in a certain direction.

Accordingly, force sensing assembly 110 may be configured to provide operating instructions to drive assembly 102. That is, a user may manipulate force sensing assembly 110 and appropriate operating instructions may be determined (e.g., by a controller disposed within force sensing assembly 110 and/or coupled to force sensing assembly 110 and configured to receive signals from force sensing assembly 110) for drive assembly 102. Such operating instructions may be communicated to drive assembly 102.

Force sensing assembly 110 may be a force sensing handlebar assembly that is positioned between the user and payload 108 to significantly reduce the effort involved in moving payload 108 by operating drive assembly 102 via commands determined by manipulation of force sensing assembly 110. Force sensing assembly 110 may, thus, operate drive assembly 102 to push, pull, and/or rotate autonomous robot 100 and, thus, payload 108. In various embodiments, force sensing assembly 110 may be positioned on various areas of autonomous robot 100 (e.g., along the top of autonomous robot 100, along the base of autonomous robot 100, in any position along autonomous robot 100, with signals from manipulation of force sensing assembly 110 wirelessly communicated to drive assembly 102 to operate drive assembly 102).

In certain embodiments, vertical orientation of a force sensing handlebar may allow for ergonomic improvements for user interactions with autonomous robot 100. For example, a human operator may instinctively grab and manipulate items with a vertically oriented hand (e.g., with the thumb of the hand located at the top). Additionally, vertical orientation allows for intuitive rotational control of autonomous robot 100 as the rotational controls may mimic the wrist rotation of the user.

### Handle Assembly Examples

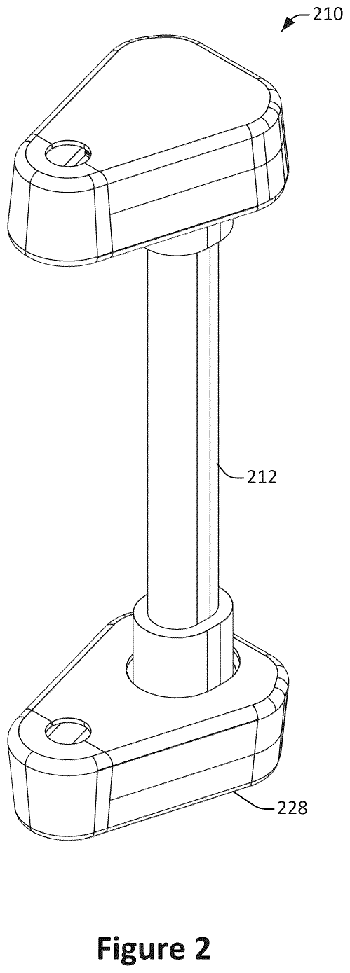

FIG. 2 illustrates a perspective view of a force sensing handlebar, configured in accordance with one or more embodiments. FIG. 2 illustrates handle assembly 210 that includes handlebar 212 and housing 228. Handlebar 212 may be a vertically or horizontally oriented handlebar configured to allow a user to grasp the handlebar to provide operating instructions to autonomous robot 100. In various embodiments, housing 228 may be configured to interface (e.g., mount) to one or more other portions of autonomous robot 100, such as to payload 108. In certain such embodiments, housing 228 may be configured to couple to a plurality of different portions of autonomous robot 100 and/or may be configured to a plurality of different versions of autonomous robots.

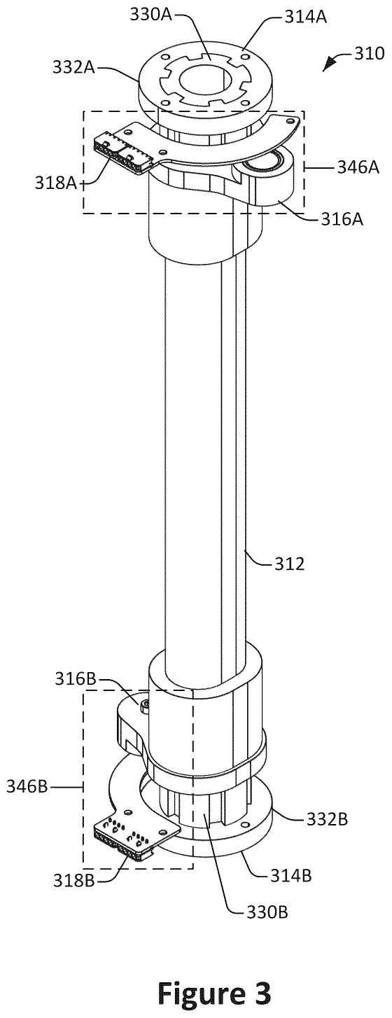

The ends of handlebar 212 may be disposed within housing 228. Housing 228 may include various sensors as well as fixtures that handlebar 212 is coupled to. The internal elements of housing 228 and handlebar 212 may be further illustrated in FIG. 3. FIG. 3 illustrates a perspective view of portions of a force sensing handlebar, configured in accordance with one or more embodiments. FIG. 3 may illustrate handle assembly 310, which may not include housing 228.

In FIG. 3, handle assembly 310 may include handlebar 312. Handlebar 312 may include a first end 332A and a second end 332B on opposite distal portions. The ends of handlebar 312 may be coupled to various fixtures. For example, first end 332A of handlebar 312 may be coupled to fixture 314A while second end 332B of handlebar 312 may be coupled to fixture 314B.

In certain embodiments, handlebar 312 may be coupled to fixtures 314A and/or 314B via compliant material 330A and/or 330B. Compliant material 330B is visible in FIG. 3, but an ordinal indicator for 330B indicates where compliant material 300B is located. Compliant material 300B is coupled to fixture 314B in a similar manner to the manner that compliant material 330A is coupled to fixture 314A. Compliant material 330A and/or 330B may be a form or material, such as a spring or bushing made from an elastomer, rubber, metal, and/or other material, that allows the position of handlebar 312 to change relative to fixtures 314A and/or 314B in response to force applied to handlebar 312 by a user. In various embodiments, compliant materials 330A and/or 330B may be coupled via casting, friction fit, fasteners, adhesives, and/or another such technique that may allow for the joining of two items (e.g., two items of different materials).

Fixtures 314A and/or 314B may be coupled to another portion of autonomous robot 100. In certain embodiments, fixtures 314A and/or 314B may be coupled to autonomous robot via another portion of handle assembly 210 that may then be coupled to autonomous robot 100. Fixtures 314A and 314B may thus be coupled to housing 228 to hold handlebar 312 in a relative position to housing 228. In another embodiment, fixtures 314A and/or 314B may be directly connected to autonomous robot 100 (e.g., via any type of direct connection such as adhesives, fasteners, welding, and/or via fasteners or other removable techniques). Compliant material 330A and/or 330B may, thus, allow for handlebar 312 to translate and/or rotate relative to fixtures 314 and/or 314B in response to force applied by the user. Furthermore, fixtures 314A and/or 314B in combination with compliant material 330A and/or 330B may be configured to hold the handlebar 312 in a fixed position (e.g., neutral position) when no force is applied to handlebar 312.

Handle assembly 310 may include first sensor 346A and second sensor 346B. First sensor 346A may include first sensor first portion 316A and first sensor second portion 318A. Second sensor 346B may include second sensor first portion 316B and second sensor second portion 318B. First sensor first portion 316A and second sensor first portion 316B may be coupled to handlebar 312. Certain embodiments may couple first sensor first portion 316A and second sensor first portion 316B proximate to opposite distal ends (e.g., first end 332A and second end 332B) of handlebar 312, but other embodiments may couple first sensor first portion 316A and second sensor first portion 316B to any portion of handlebar 312.

First sensor second portion 318A and second sensor second portion 318B may be coupled to portions of handle assembly 310 and/or autonomous robot 100 that handlebar 312 may be configured to move relative to. That is, first sensor second portion 318A and second sensor second portion 318B may be coupled to, for example, housing 228, fixtures 314A and 314B, respectively, and/or another portion of autonomous robot 100. Thus, first sensor second portion 318A and second sensor second portion 318B may be held in a “fixed” position (e.g., fixed relative to another portion of autonomous robot 100 such as payload 108) so that movement of handlebar 312 may cause first sensor first portion 316A and second sensor first portion 316B to move relative to first sensor second portion 318A and second sensor second portion 318B.

Relative movement of first sensor first portion 316A to first sensor second portion 318A and second sensor first portion 316B to second sensor second portion 318B may allow for a determination as to whether a user is pushing on or rotating handlebar 312. Based on the user's interaction with handlebar 312 (e.g., whether the user is pushing on or rotating handlebar 312), autonomous robot 100 may be driven in different manners. Such techniques may be further described herein. In certain embodiments, first sensor first portion 316A and first sensor second portion 318A and second sensor first portion 316B and second sensor second portion 318B may be offset in different positions (e.g., different positions along a vertical axis for vertically oriented handlebars or different positions along a horizontal axis for horizontally oriented handlebars) to allow for distinguishing of translational and rotational operating instructions.

In certain embodiments, first sensor first portion 316A and second sensor first portion 316B and first sensor second portion 318A and second sensor second portion 318B, respectively, may be configured to interact. For example, first sensor second portion 318A may be configured to sense movement of first sensor first portion 316A relative to first sensor second portion 318A. Second sensor second portion 318B may be configured to sense movement of second sensor first portion 316B relative to second sensor second portion 318B. Such relative movement may be, for example, due to deflection of compliant materials 330A and/or 330B from forces applied to handlebar 312.

In a certain embodiment, first sensor first portion 316A and second sensor first portion 316B may be magnets while first sensor second portion 318A and second sensor second portion 318B may include hall effect sensor modules (e.g., 1-axis, 2-axis, or 3-axis hall effect sensors) that includes one or a plurality of hall effect sensors. The hall effect sensor modules may be configured to sense the respective movement of the magnets, or vice versa. Utilizing a plurality of paired sensor portions that are offset from each other allows for measurement of twist theta in addition to that of relative displacement, allowing for estimates of applied force (e.g., linear force) as well as applied torque (e.g., twisting force). Other embodiments may include other types of sensors for first sensor first portion 316A, second sensor first portion 316B, first sensor second portion 318A, and/or second sensor second portion 318B, such as optical flow sensor, optical or magnetic encoders, potentiometers, ultrasonic sensors, and/or other such sensors.

### Sensing Examples

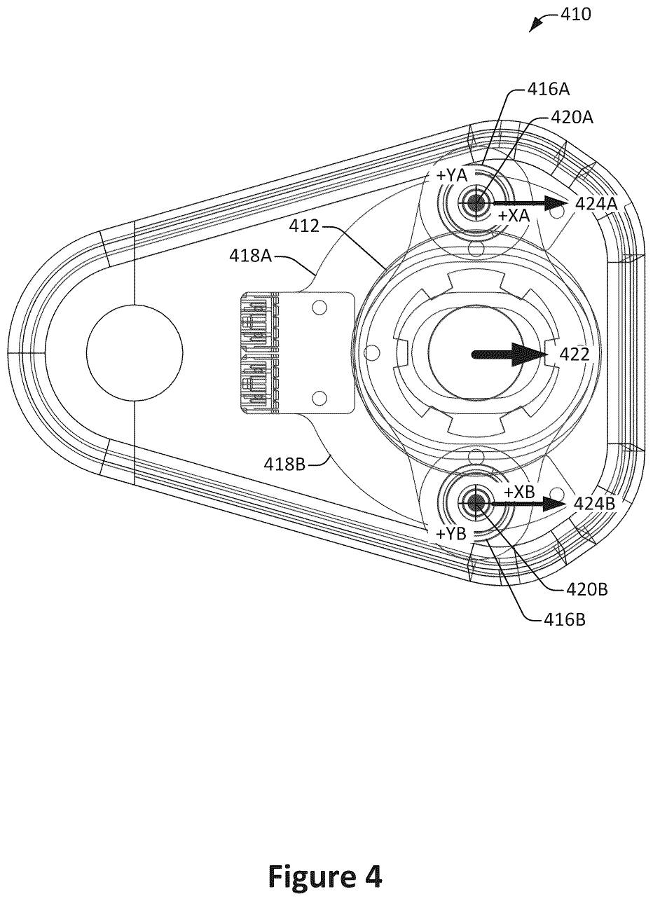

FIG. 4 illustrates a top view of a force sensing handlebar for an autonomous robot in a first manipulated position, configured in accordance with one or more embodiments. FIG. 4 may illustrate linear force 422 applied to handlebar 412 of handle assembly 410. In certain embodiments, linear force 422 applied to handlebar 412 may result in drive assembly 102 linearly moving (e.g., translating) autonomous robot 100, according to the techniques described herein. The speed of linear movement may be dependent on the magnitude of the detected force applied to handlebar 412.

Movement of first sensor first portion 416A may be determined relative to sensor axis 420A. When no force is applied to the handlebar of handle assembly 410, first sensor first portion 416A may be determined to be disposed at the center, or proximate the center (e.g., within a set degree of tolerance, such as within a few millimeters), of sensor axis 420A and may be determined to be disposed in a neutral position. First sensor second portion 418A may be calibrated to determine the position of first sensor first portion 416A. First sensor second portion 418A may be calibrated such that when first sensor first portion 416A is disposed in the neutral position (e.g., at the center or proximate the center of sensor axis 420A), first sensor second portion 418A may determine that there is no relative movement of first sensor first portion 416A.

Additionally, first sensor second portion 418A may be configured to detect movement of first sensor first portion 416A along two axes (e.g., XA and YA). Thus, when force is applied to the handlebar, in certain instances, first sensor first portion 416A may move along the XA and/or YA axes (e.g., in the positive or negative XA and/or YA directions relative to sensor axis 420A) and such movement may be detected by first sensor second portion 418A. Similarly, movement of second sensor first portion 416B may be determined by second sensor second portion 418B, relative to sensor axis 420B, the center of which may be a neutral position that second sensor second portion 418B is calibrated towards.

Linear force 422 may be applied to handlebar 412. Due to the application of linear force 422, first sensor first portion 416A may move relative to first sensor second portion 418A. Such movement may be determined as positive or negative according to defined axes. Thus, in certain embodiments, movement in the positive XA direction and the positive YA direction may be classified as positive magnitude, while movement in the opposite direction may be classified as negative magnitude. Similarly, second sensor second portion 418B may be configured to determine movement of second sensor first portion 416B in the positive and negative XB and YB directions, as shown. In certain embodiments, the positive directions of XA and XB may be in the same direction while the positive directions of YA and YB may be in opposite directions. The positive and negative directions may allow for the determination of whether handlebar 412 is translating or rotating. Other orientations of the axes may be possible in other embodiments.

As shown in FIG. 4, linear force 422 applied to handlebar 412 may cause reaction 424A for first sensor first portion 416A (e.g., reaction 424A may be movement of first sensor first portion 416A in the positive XA direction) and may cause reaction 424B for second sensor first portion 416B (e.g., reaction 424B may be movement of second sensor first portion 416B in the positive XB direction). The reactions of first sensor first portion 416A and second sensor first portion 416B may be detected by first sensor second portion 418A and second sensor second portion 418B, respectively. Based on the determination that first sensor first portion 416A is moving in the positive XA direction and second sensor first portion 416B is moving in the positive XB direction, a determination may be made (e.g., by a controller as described herein) that force 422 is causing handlebar 412 to translate as both first sensor first portion 416A and second sensor first portion 416B may both be determined to be moving in the same direction, along the same vector, and/or with the same magnitude of movement.

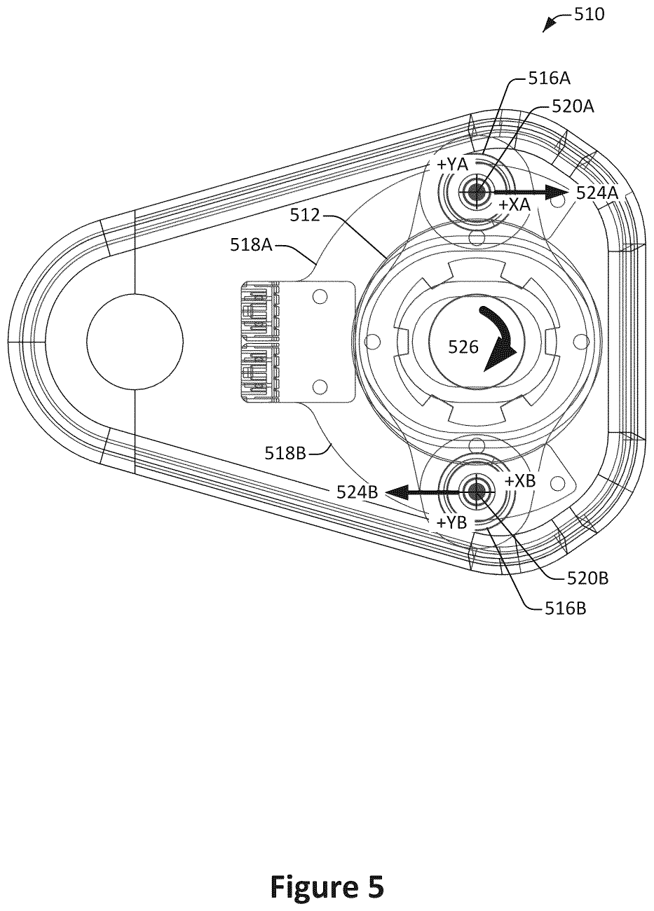

FIG. 5 illustrates a top view of a force sensing handlebar for an autonomous robot in a second manipulated position, configured in accordance with one or more embodiments. FIG. 5 may illustrate torque 526 applied to handlebar 512 of handle assembly 510. Torque 526 may be, for example, a twisting motion applied by a user. Application of torque 526 may cause the orientation of handlebar 512 to accordingly twist, resulting in reaction 524A for first sensor first portion 516A, which may be movement of first sensor first portion 516A in at least the positive XA direction, and reaction 524B for second sensor first portion 516B, which may be movement of second sensor first portion 516B in at least the negative XB direction. In certain embodiments, first sensor first portion 516A may additionally or alternatively move in the negative YA direction and second sensor first portion 516B may additionally or alternatively move in the negative YB direction.

Based on the determination that first sensor first portion 516A is moving in the positive XA direction and second sensor first portion 516B is moving in the negative XB direction, a determination may be made that torque 526 is causing handlebar 512 to rotate. Drive assembly 102 may be then operated to cause autonomous robot 100 to rotate orientations. Other embodiments may determine other types of rotation (e.g., with the first sensor first portion 516A moving in the negative XA direction and the second sensor first portion 516B moving in the positive XB direction).

In the examples of FIGS. 4 and 5, in addition to determination of the type and direction of movement of the handlebar, the magnitude of the force and/or torque applied may also be determined. Such magnitude may be determined based on the stiffness factor of fixtures 314A and 314B and/or compliant materials 330A and 330B. Thus, it is appreciated that disposing the first sensor portions as close as possible to their respective fixtures may provide a simpler technique for determination of movement of the handlebar at the position of the respective fixtures.

In such a technique, the magnitude may be determined based on the relationship of F=kx and x=Bk/m, where k is the stiffness factor from the fixture and/or compliant materials and m is a factor relating distance to magnetic flux output from a hall effect sensor (e.g., as the magnet of the first sensor portion is disposed farther away from the hall effect sensor of the second sensor portion, the flux output by the hall effect sensor changes, allowing for determination of the distance between the first sensor portion and its respective second sensor portion). The lumped parameter k/m may be an empirically determined factor relating force and magnetic flux. In certain embodiments, such as embodiments where the hall effect sensor is one or more 3-axis (3 degree of freedom) hall effect sensors, the differences in magnetic flux based on the orientation of the magnet may be detected and, accordingly, whether the magnet is moving in the X or Y direction may be determined.

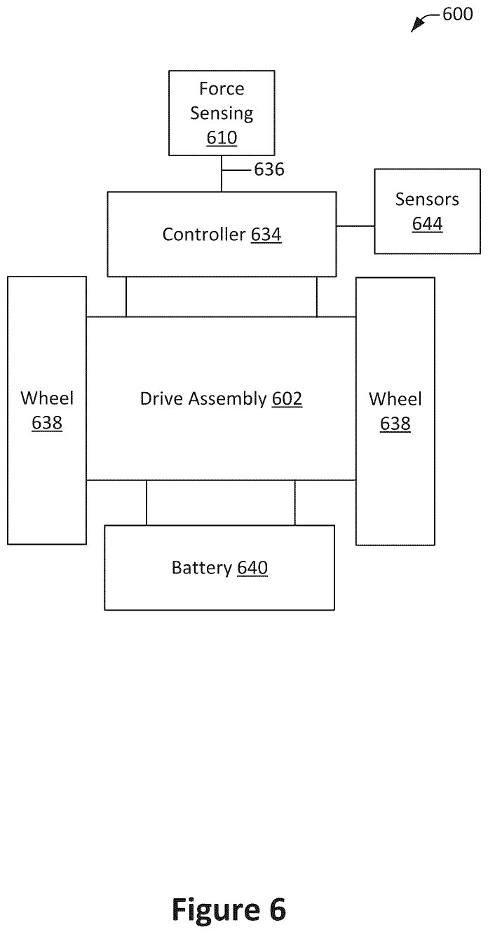

FIG. 6 is a block diagram of a drive unit for an autonomous robot, configured in accordance with one or more embodiments. FIG. 6 illustrates autonomous robot 600, which may include drive assembly 602 configured to power a plurality of drive wheels 638, controller 634, force sensing assembly 610, battery 640, sensors 644, and circuitry 636.

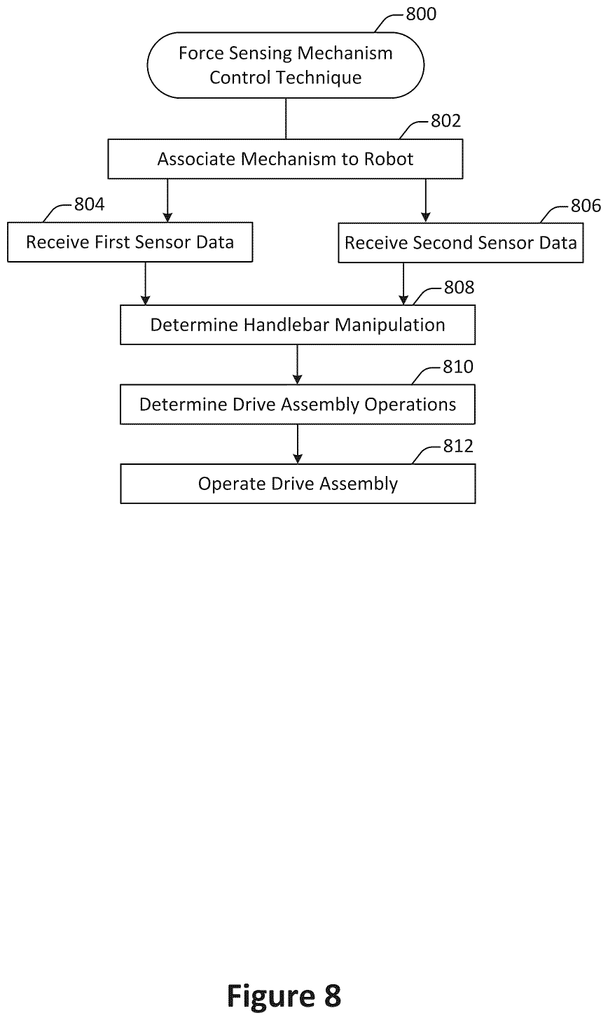

Controller 634 may be one or more control units that includes one or more processors, memories, and/or other circuitry configured to receive, process, and provide signals/data. Various elements of controller 634 may be further described in FIG. 8. Controller 634 may receive signals from force sensing assembly 610 (e.g., the various sensors of force sensing assembly 610 indicating user interface with a handlebar) and/or sensors 644 via circuitry 636. Such signals may cause controller 634 to provide instructions to drive assembly 602 to operate the various drive units of drive assembly 602 according to the determined instructions.

In various embodiments, controller 634 may be a controller of autonomous robot 600 (e.g., of drive assembly 602) and/or may be a controller disposed within the assembly of force sensing assembly 610 (e.g., may be a controller disposed within handle assembly 210 in, for example, housing 228). Various embodiments may include one or a plurality of controllers disposed within autonomous robot 100 and/or force sensing assembly 610.

Electrical signals and/or data may be communicated between the various elements of autonomous robot 600 via circuitry 636. Circuitry 636 may be any type of wired and/or wireless circuitry for communicating data, electrical signals, and/or electrical power. Electrical power may be stored within battery 640 and provided to drive assembly 602 according to instructions provided by controller 634.

In certain embodiments, force sensing assembly 610 may include a vertically or horizontally mounted handlebar and/or a force sensitive base, as described herein. Force sensing assembly 610 may be equivalent to, for example, handle assembly 310 as described herein and may include all such components, including the sensors and/or sensor portions. Force sensing assembly 610 may, in various embodiments, be fixed to autonomous robot 600, removably mounted to autonomous robot 600 but associated specifically with autonomous robot 600 (e.g., configured to only control a certain autonomous robot), or may be configured to control various autonomous robots (e.g., force sensing assembly 610 may be configured to couple to a plurality of different autonomous robots and, when coupled to a specific autonomous robot, may control the specific autonomous robot when manipulated).

Sensors 644 may be any sensor configured to aid in the operation of autonomous robot 600, such as aid in determining operating routes and/or parameters for drive unit 804 and/or determining conditions around the environment of autonomous robot 600. Thus, sensors 644 may be one or more of a radar, lidar, visual camera, thermal camera, and/or other such sensor. Sensors 644 may provide input to controller 634 to determine operating instructions for autonomous robot 600, including for operation of the drive units or the drive assembly.

Sensors 644 may be any sensor configured to aid in the operation of autonomous robot 600, such as aid in determining operating routes and/or parameters for drive unit 804. Thus, sensors 644 may be one or more of a radar, lidar, visual camera, thermal camera, and/or other such sensor. Sensors 644 may provide input to controller 634 to determine operating instructions for autonomous robot 600, including for operation of the drive units or the drive assembly.

Additionally or alternatively, sensors 644 may include one or more environmental sensors configured to determine the condition of the environment around autonomous robot 600. For example, sensors 644 may include a camera (visual or thermal) or other sensor configured to determine a presence of a user proximate autonomous robot 600. In certain situations, there may be accidental contact between force sensing assembly 610 and the environment (e.g., due to bumping). In certain embodiments, controller 634 may determine whether a user is proximate autonomous robot 100 and/or proximate force sensing assembly 610 (e.g., located within a meter of force sensing assembly 610 and, thus, within arm's reach). If no user is determined, inputs from force sensing assembly 610 may be ignored, but if a user is indicated to be proximate force sensing assembly 610 and/or determined to be interacting with force sensing assembly 610 (e.g., sensors 644 may detect that the user is touching force sensing assembly 610), controller 634 may determine operating instructions to drive assembly 602 based on inputs from force sensing assembly 610.

### Operation Examples

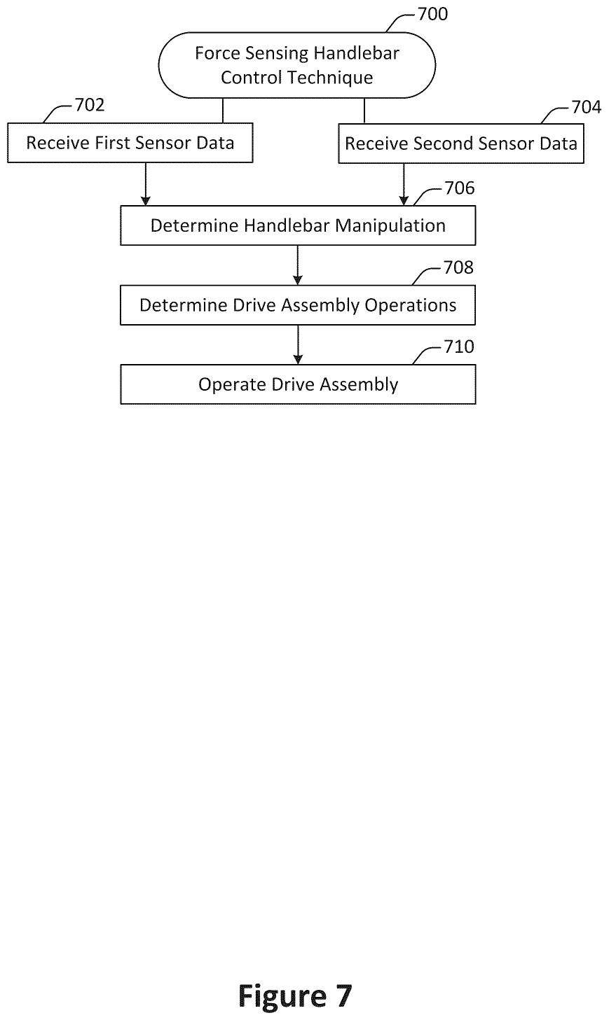

FIG. 7 is a flowchart detailing techniques for utilizing a force sensing handlebar, configured in accordance with one or more embodiments. FIG. 7 may illustrate force sensing handlebar control technique 700 for operating an autonomous robot with a force sensing handlebar.

In 702 and 704, sensor data from different sensors coupled to the handlebar may be received (e.g., by a controller). For example, one or more controllers of the autonomous robot may receive sensor data from various second sensor portions, which may be configured to detect relative positioning of first sensor portions and provide data directed to such relative positioning. In certain embodiments, such second sensor portions may include hall effect sensors for detection of relative positioning of the first sensor portions. The axes of the sensors providing data in 702 and 704 may be offset to allow for determination of translation or rotation of the handlebar.

In certain embodiments, the sensor data of 702 and/or 704 may indicate that a user is manipulating the handlebar. That is, the sensor data of 702 and/or 704 may indicate that a user is, for example, providing a translational (e.g., pushing or pulling) and/or rotational (e.g., twisting) force on the handlebar. Based on the data provided by the sensors, user manipulation of the handlebar may be determined in 706. Such determination may include the type of manipulation (e.g., translation or rotation) as well as the magnitude of the manipulation. Such type and magnitude may be according to the techniques described herein.

Based on the type and magnitude of the manipulation of the handlebar determined in 706, operating instructions for the drive assembly may be determined in 708 and the drive assembly may be accordingly operated in 710. For example, linear force on the handlebar may cause the drive assembly to move the autonomous robot in a linear direction while rotation (e.g., twisting) of the handlebar may cause the drive assembly to rotate the autonomous robot.

Furthermore, the force sensing assembly may be utilized for weight sensing and/or adjustment of the output by the drive assembly. For example, a force sensing assembly that is a force sensing base may allow for detection of vertical deflection of the compliant material. The compliant material may vertically deflect from load and the deflection of the compliant material may allow for a determination of the amount (e.g., weight) of the load that is carried by the autonomous robot. Based on the determined load, the drive assembly output (e.g., torque and/or speed output) may be adjusted to compensate for the load (e.g., torque output may be increased if a higher load is detected).

Load sensing may also be determined based on drive assembly operation or user inputs through other manners. For example, a user may, when the drive assembly is operating, push harder on a vertical or horizontal handlebar, causing additional deflection within the compliant material. Based on the additional deflection, the controller may determine that the user desires for higher output from the drive assembly and that the movement of the autonomous robot is slower than the user expects. Accordingly, the controller may cause the drive assembly to provide greater output based on a fixed amount of deflection for future user manipulations of the force sensing mechanism.

Additionally or alternatively, the drive assembly may include sensors to determine the travel velocity (e.g., translational or rotational) and a determination may be made that the velocity is slower than expected for a given amount of deflection of the compliant material. The drive assembly output may accordingly be increased based on such a determination.

In certain embodiments, the drive assembly may include a plurality of drive units, such as two or more drive units where each drive unit includes a plurality of independently operable motors that may each operate different drive wheels of the drive unit. In certain such embodiments, each drive unit may include a freely rotating coupling. Additional details of the drive assembly and the operation thereof may be provided by, for example, U.S. patent application Ser. No. 18/622,640, entitled “Autonomous Robot Double Drive Assembly”, filed 2024 Mar. 29, which is incorporated herein by reference in its entirety for all purposes.

FIG. 8 is a flowchart detailing another technique for utilizing a force sensing handlebar, configured in accordance with one or more embodiments. FIG. 7 may illustrate force sensing assembly control technique 800 for operating an autonomous robot with a force sensing assembly. The force sensing assembly may be any mechanism as described herein, including force sensing handlebars and bases.

In 802, the force sensing assembly may be associated with the autonomous robot. In certain embodiments, the force sensing assembly may be coupled to the autonomous robot (e.g., mounted on the autonomous robot), paired with the autonomous robot (e.g., removable but paired to the autonomous robot so that a user may couple to the mechanism to the autonomous robot when user input is desired), and/or associated with autonomous robots (e.g., may be a general usage mechanism that may be coupled to a plurality of autonomous robots or types of autonomous robots to operate such autonomous robots as desired).

For example, in certain embodiments, the autonomous robot may include one or more interfaces (e.g., connectors) configured to receive the force sensing assembly. Such interfaces may include connectors that may allow for data connections between the force sensing assembly and the controllers of the autonomous robot. Thus, a user that wishes to provide user input to an autonomous robot may associate the mechanism to the autonomous robot by, for example, coupling the mechanism to the connector to achieve a data connection. Once coupled, sensor data from the sensors of the force sensing assembly may be provided to the autonomous robot.

In certain such embodiments, a single force sensing assembly may be paired with a single autonomous robot or a type of autonomous robot. Thus, a user may include their own mechanism that may be coupled to the autonomous robot when the user may wish to provide instructions to the autonomous robot. Furthermore, the force sensing assembly may be utilized to, for example, allow for first responders to move autonomous vehicles in emergency situations.

Once the force sensing assembly is associated to the robot in 802, the force sensing assembly may be operated in 804 to 812. 804 to 812 may be equivalent to, for example, 702 to 710 of the technique described in FIG. 7.

### Additional Configurations

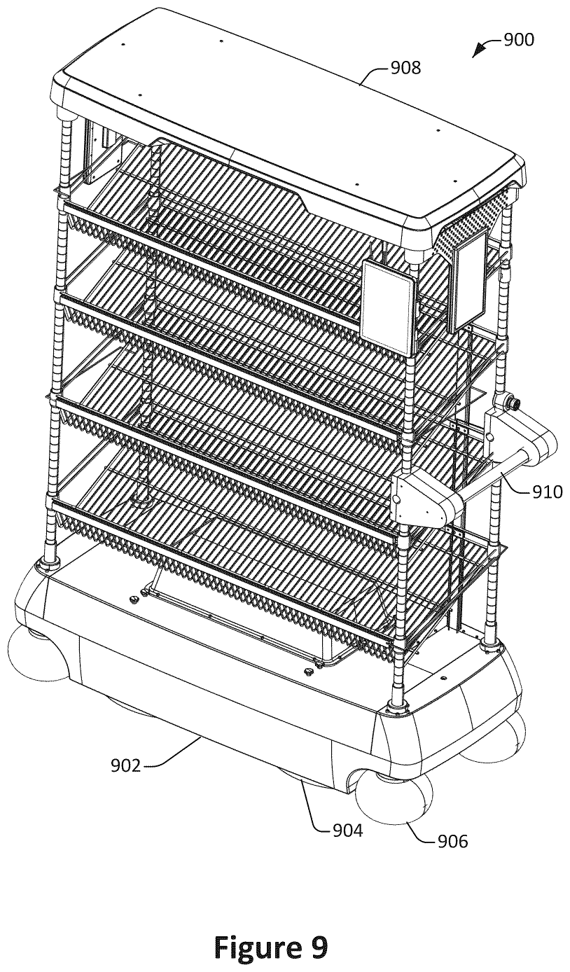

FIG. 9 illustrates a perspective view of an autonomous robot with a horizontal handlebar, configured in accordance with one or more embodiments. FIG. 9 illustrates autonomous robot 900 that includes drive assembly 902 with drive unit 904, payload support element 906, payload 908, and force sensing assembly 910. As shown in FIG. 9, force sensing assembly 910 may include a horizontal handlebar. The horizontal handlebar of FIG. 9 may include sensors, as described herein, disposed at one or both ends (e.g., the horizontal ends) and/or other portions of the handlebar. In certain embodiments, translational pushes on the horizontal handlebar may cause autonomous robot 900 to translate, but twisting of the horizontal handlebar (e.g., around a vertical axis such that, for example, one end of the handlebar may be moved “forward” while the other end may be moved “backward”) may cause rotation of autonomous robot 900.

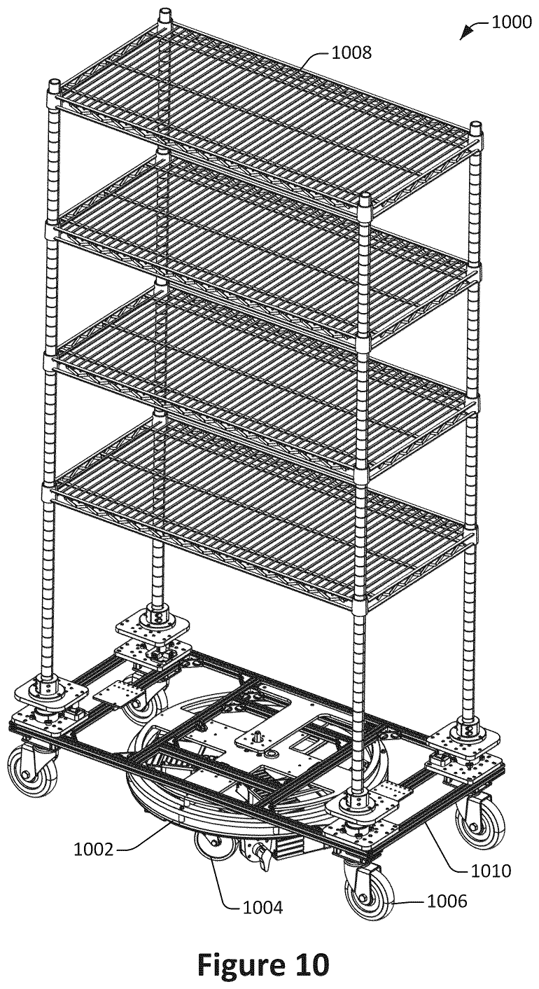

FIG. 10 illustrates a perspective view of an autonomous robot with a force sensing base, configured in accordance with one or more embodiments. FIG. 10 illustrates autonomous robot 1000 that includes drive assembly 1002 with drive unit 1004, payload support element 1006, payload 1008, and force sensing assembly 1010. As shown in FIG. 9, force sensing assembly 1010 may include a force sensing base. A user may interact with the force sensing base by, for example, pushing or pulling on the force sensing base with a variety of different force input directions to cause autonomous robot 1000 to translate and/or rotate (e.g., based on pushes that are orthogonal to force sensing assembly 1010 to cause translational movement or pushes that are on the bias, such as within +/−15 degrees of 45 degrees, to force sensing assembly 1010 to cause rotational movement). Furthermore, as the sensors are agnostic as to whether payload 1008 or force sensing assembly 1010 is being pushed/pulled due to the sensors being configured to determine relative movement between payload 1008 and force sensing assembly 1010, a user may also push or pull on payload 1008 to translate and/or rotate autonomous robot 1000 in a similar manner to that of interacting with the base.

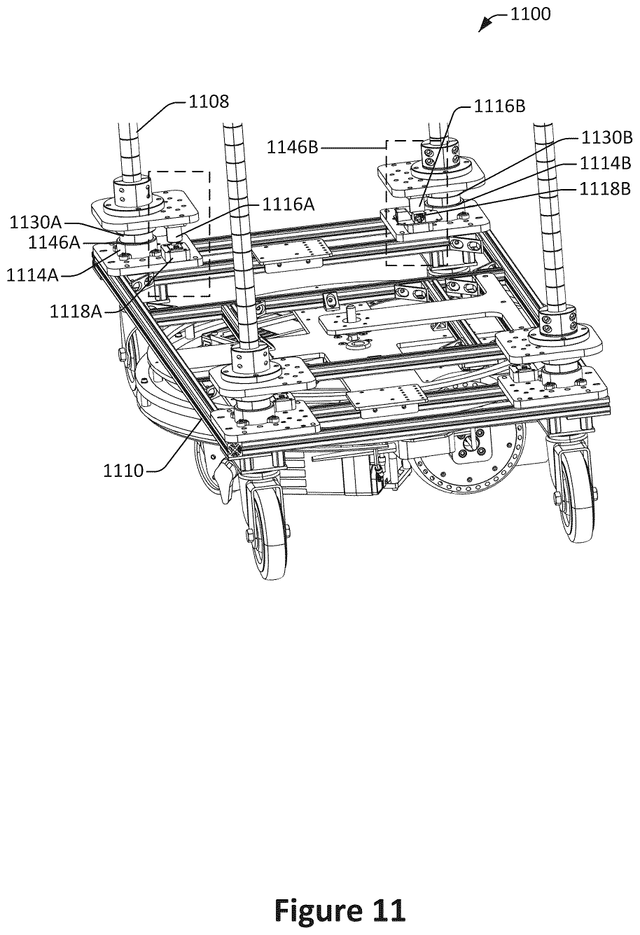

FIG. 11 illustrates a perspective view of portions of a force sensing base, configured in accordance with one or more embodiments. FIG. 11 illustrates autonomous robot 1100 that includes force sensing assembly 1110 that may be a force sensing base. As shown, force sensing base 1010 may include a plurality of sensors including first sensor 1146A and second sensor 1146B, as well as additional sensors.

In certain embodiments, first sensor 1146A may include first sensor first portion 1116A coupled to a portion of payload 1108 and first sensor second portion 1118A coupled to a portion of force sensing assembly 1110. Additionally, fixture 1114A, which may include compliant material 1130A configured in the same manner as that described herein, may allow for movement of payload 1108 relative to force sensing base 1110 (e.g., in response to user inputs). Such movement may result in first sensor first portion 1116A moving relative to first sensor second portion 1118A, due to the compliance of the compliant material.

Similarly, second sensor 1146B may include second sensor first portion 1116B, coupled to payload 1108, and second sensor second portion 1118B, coupled to force sensing assembly 1110. Similarity or differences in the detected movement of first sensor first portion 1116A and second sensor first portion 1116B, as described herein, may result in a determination of whether autonomous robot 1100 is moved in a translational or rotational manner.

### Controller Example

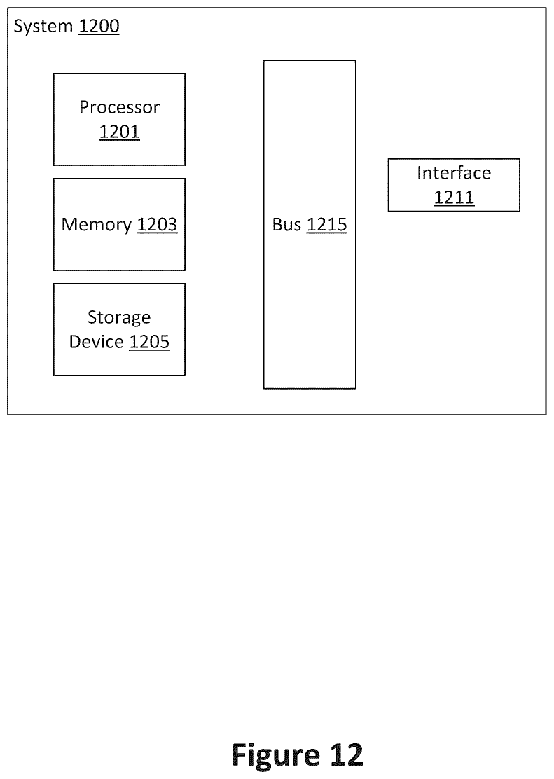

FIG. 12 is a block diagram of a computing device, configured in accordance with one or more embodiments. According to various embodiments, a system 1200 suitable for implementing embodiments described herein includes a processor 1201, a memory module 1203, a storage device 1205, an interface 1211, and a bus 1215 (e.g., a PCI bus or other interconnection fabric.) System 1200 may operate as variety of devices such as cleaning robot, remote server, or any other device or service described herein. Although a particular configuration is described, a variety of alternative configurations are possible. The processor 1201 may perform operations such as those described herein. Instructions for performing such operations may be embodied in the memory 1203, on one or more non-transitory computer readable media, or on some other storage device. Various specially configured devices can also be used in place of or in addition to the processor 1201. The interface 1211 may be configured to send and receive data packets over a network. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

### Conclusion

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of industrial autonomous mobile robots configured for operation in a warehouse setting. However, the techniques of the present invention apply to a wide variety of autonomous mobile robots configured for operation in a wide variety of settings. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. An autonomous robot comprising:
a drive assembly;
a controller; and
a handle assembly, comprising:
a handlebar;
a first fixture coupled to the handlebar at a first end of the handlebar;
a second fixture coupled to the handlebar at a second end of the handlebar;
a first sensor comprising a first sensor first portion coupled to the handlebar proximate the first end of the handlebar and a first sensor second portion disposed proximate the first sensor first portion, wherein the first sensor first portion is configured to move relative to the first sensor second portion in response to movement of the handlebar, and wherein the first sensor second portion is configured to detect the relative movement of the first sensor first portion and output first sensor data to the controller; and
a second sensor comprising a second sensor first portion coupled to the handlebar proximate the second end of the handlebar and a second sensor second portion disposed proximate the second sensor first portion, wherein the second sensor first portion is configured to move relative to the second sensor second portion in response to movement of the handlebar, and wherein the second sensor second portion is configured to detect the relative movement of the second sensor first portion and output second sensor data to the controller.

2. The autonomous robot of claim 1, wherein the handlebar is a vertically oriented handlebar.

3. The autonomous robot of claim 2, wherein the first sensor first portion is configured to be disposed in a first neutral position, and wherein the second sensor first portion is configured to be disposed in a second neutral position.

4. The autonomous robot of claim 3, wherein the first neutral position and the second neutral position are located along different vertical axes.

5. The autonomous robot of claim 1, wherein the first sensor data is associated with the relative movement of the first sensor first portion to the first sensor second portion.

6. The autonomous robot of claim 1, wherein the second sensor data is associated with the relative movement of the second sensor first portion to the second sensor second portion.

7. The autonomous robot of claim 1, wherein the controller is configured to:
receive the first sensor data and the second sensor data;
determine, based on the first sensor data and the second sensor data, user interaction with the handlebar; and
cause the drive assembly to provide motive force.

8. The autonomous robot of claim 7, wherein the user interaction is determined to be a translation of the handlebar, and wherein the motive force results in translational movement of the drive assembly.

9. The autonomous robot of claim 7, wherein the user interaction is determined to be a twist of the handlebar, and wherein the motive force results in rotational movement of the drive assembly.

10. The autonomous robot of claim 1, wherein the handle assembly further comprises:
a first compliant material, coupled to the first fixture and the handlebar and configured to allow the handlebar to move relative to first fixture; and
a second compliant material, coupled to the second fixture and the handlebar and configured to allow the handlebar to move relative to second fixture.

11. A handle assembly comprising:
a handlebar;
a first fixture coupled to the handlebar at a first end of the handlebar;
a second fixture coupled to the handlebar at a second end of the handlebar;
a first sensor comprising a first sensor first portion coupled to the handlebar proximate the first end of the handlebar and a first sensor second portion disposed proximate the first sensor first portion, wherein the first sensor first portion is configured to move relative to the first sensor second portion in response to movement of the handlebar, and wherein the first sensor second portion is configured to detect the relative movement of the first sensor first portion and output first sensor data; and
a second sensor comprising a second sensor first portion coupled to the handlebar proximate the second end of the handlebar and a second sensor second portion disposed proximate the second sensor first portion, wherein the second sensor first portion is configured to move relative to the second sensor second portion in response to movement of the handlebar, and wherein the second sensor second portion is configured to detect the relative movement of the second sensor first portion and output second sensor data.

12. The handle assembly of claim 11, wherein the handlebar is configured to be vertically oriented.

13. The handle assembly of claim 12, wherein the first sensor first portion is configured to be disposed in a first neutral position, and wherein the second sensor first portion is configured to be disposed in a second neutral position.

14. The handle assembly of claim 13, wherein the first neutral position and the second neutral position are located along different vertical axes.

15. The handle assembly of claim 11, wherein the first sensor data is associated with the relative movement of the first sensor first portion to the first sensor second portion.

16. The handle assembly of claim 11, wherein the second sensor data is associated with the relative movement of the second sensor first portion to the second sensor second portion.

17. The handle assembly of claim 11, further comprising a controller, configured to:
receive the first sensor data and the second sensor data;
determine, based on the first sensor data and the second sensor data, user interaction with the handlebar; and
provide drive data to a robotic drive assembly.

18. The handle assembly of claim 17, wherein the controller is configured to determine that the user interaction is a translation of the handlebar, and wherein the drive data is configured to cause the robotic drive assembly to provide translational movement.

19. The handle assembly of claim 17, wherein the controller is configured to determine that the user interaction is a twist of the handlebar, and wherein the drive data is configured to cause the robotic drive assembly to provide rotational movement.

20. The handle assembly of claim 11, wherein the handle assembly further comprises:
a first compliant material, coupled to the first fixture and the handlebar and configured to allow the handlebar to move relative to first fixture; and
a second compliant material, coupled to the second fixture and the handlebar and configured to allow the handlebar to move relative to second fixture.
